(19) United States
(12) Patent Application Publication
(10) Pub. No.: US 2011/0093551 A1
(43) Pub. Date: Apr. 21, 2011

(54) PERSONAL ASSISTANCE SERVICE WITH INSTANT MESSAGING

(76) Inventor: Nikhil M. Deshpande, Beaverton, OR (US)

(21) Appl. No.: 12/976,396

(22) Filed: Dec. 22, 2010

Related U.S. Application Data
(63) Continuation of application No. 09/940,755, filed on Aug. 28, 2001.

(51) Int. Cl. G06F 15/16

(52) U.S. Cl. 709/206

(57) ABSTRACT

A method, apparatus, and signal-bearing media for communicating information relative to the location of a mobile device via an instant message. A mobile device may request information from an instant-messaging server, which personalizes the information to the location of the mobile device.

### FIELD

This invention relates generally to communication between a mobile device and a server and more particularly to communication between a mobile device and a personal assistance service at an instant-messaging server.

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright © Intel, Incorporated, 2001. All Rights Reserved.

### BACKGROUND

Years ago, people lived their entire lives in the same community and rarely ventured beyond its borders. Over a lifetime, they accumulated knowledge about their community and the businesses and services that were available in it. Today, the world is much different, and people are much more mobile. Travelers often find themselves in an unfamiliar city or country with little knowledge of the local services, such as where to find a hotel, restaurant, or gas station. Travelers often resort to scanning the telephone book looking for such services. But, a telephone may have hundreds of entries in a single category with no way to tell which street address is convenient to the traveler's current location and which is far away.

Many people carry mobile electronic devices, such as laptop or notebook computers, handheld computers, cellular telephones, pagers, and PDAs (Personal Digital Assistants). These devices often allow communication with other people, but they lack the ability to provide information tailored to the user's current location.

What is needed is a way for a user to receive assistance personalized to the user's current location.

### BRIEF DESCRIPTION OF THE DRAWINGS

FIG. 1 depicts a schematic overview of the architecture of an embodiment of the invention.

FIG. 2 depicts a block diagram of an instant-messaging server, according to an embodiment of the invention.

FIG. 3 depicts a block diagram of a mobile device, according to an embodiment of the invention.

FIG. 4 depicts a block diagram example of a user interface on a display of a mobile device, according to an embodiment of the invention.

FIG. 5 depicts a flowchart of processing, according to an embodiment of the invention.

### DETAILED DESCRIPTION

In the following detailed description of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known circuits, structures and techniques have not been shown in detail in order not to obscure the invention.

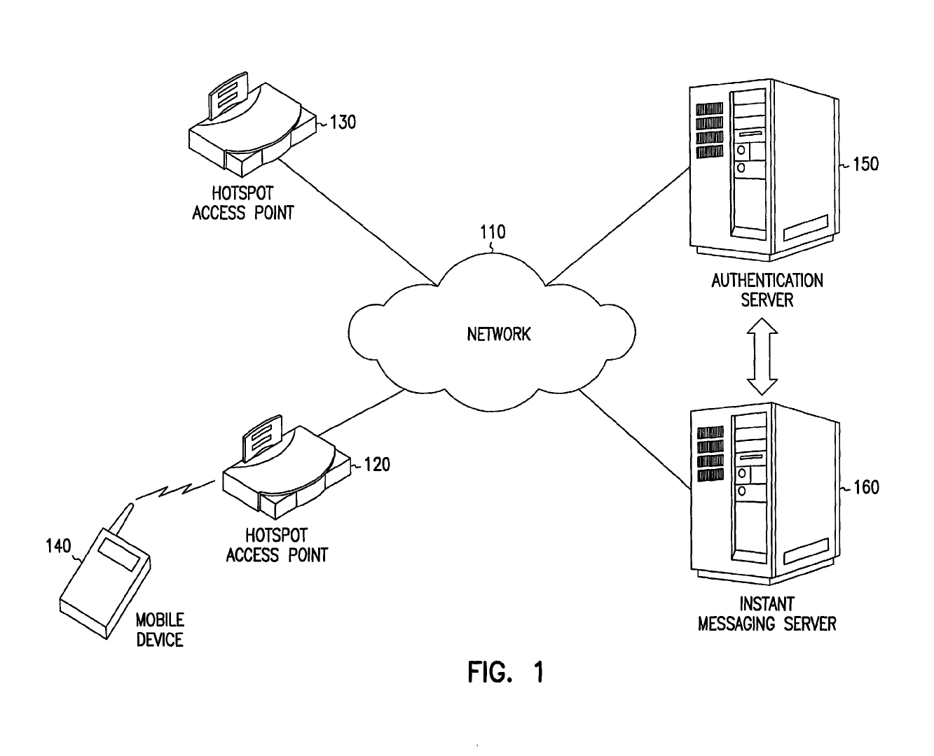

FIG. 1 depicts a schematic overview of the architecture of an embodiment of the invention. According to this embodiment, instant-messaging server 160 provides location-based services to mobile device 140 via network 110, hotspot-access points 120 and 130, and authentication server 150.

Network 110 is connected to hotspot-access points, such as hotspot-access point 120 and hotspot-access point 130. A hotspot may be a wireless access point electronic device strategically located for providing wireless mobile devices, such as mobile device 140, access to network 110. Typical hotspots may be in locations such as airports, hotels, restaurants, and stadiums where mobile devices, such as mobile device 140, may want to make a connection to network 110 and obtain services. Although only two hotspot-access points 120 and 130 are shown, in other embodiments any number may be present. In an embodiment, hotspot-access point 120 and/or 130 may be Intel Corporation's PRO/Wireless 2011 LAN Access Point device. In other embodiments, hotspot-access point 120 and/or 130 may be any appropriate hotspot-access point.

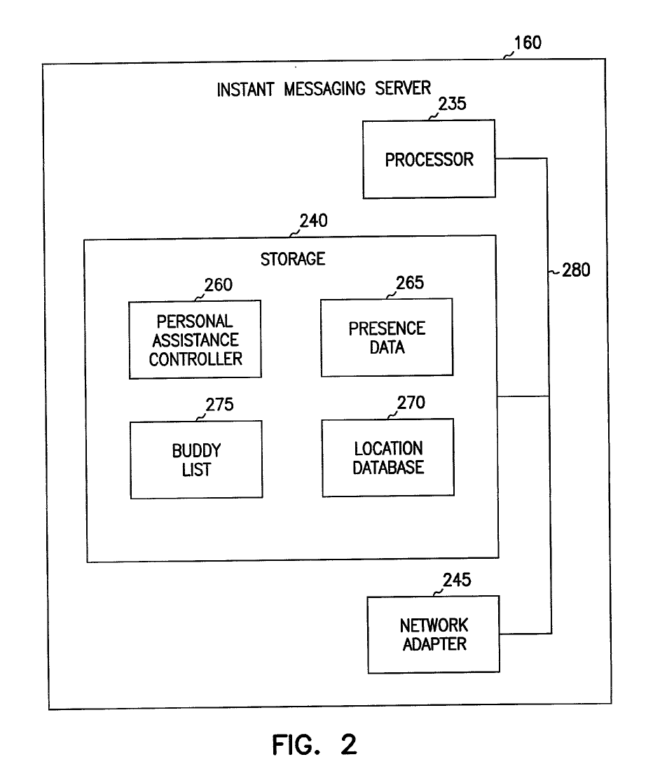

Network 110 may be any suitable network capable of supporting instant messaging. Instant messaging is different from electronic mail (email). Email is passed between nodes in a network using a “store-and-forward” technique where an email is stored at a node in a network until a short-lived connection is established to the next node, at which time the email is passed along. Eventually, after traveling through possibly multiple nodes, the email arrives at the destination node. In contrast, instant messaging delivers messages faster than email and allows text-based communication to occur in a rapid, conversational fashion. Whereas email is a store-and-forward system based on short-lived connections, recipients listening for instant messages remain connected to their server on a long-lived connection. This long-lived connection allows instant messages to be delivered in close to real time. A further difference of instant messaging from email is that email is fundamentally built on one-way message passing, while an instant-messaging system may be built on request-reply pairs. Yet another difference of instant-messaging from email is that in an embodiment, instant-messaging may have the concept of presence information, which is further described below with reference to FIG. 2.

Although one network 110 is shown, in other embodiments any number of networks may be present and mobile devices may use the same network or different networks. In an embodiment, network 110 may support wireless communications. In another embodiment, network 110 may support hard-wired communications, such as a telephone line or cable. Network 110 may support any appropriate protocol suitable for instant messaging. In an embodiment, network 110 may be the Internet and supports IP (Internet Protocol). In another embodiment, network 110 may be a local area network (LAN) or a wide area network (WAN). In another embodiment, network 110 may be a hotspot service provider network. In another embodiment, network 110 may be an intranet. In still another embodiment, network 110 may be any suitable network or combination of networks, such as a hotspot service-provider network combined with the Internet.

Mobile device 140 makes a connection with network 110 by moving into the range of hotspot-access point 120 or 130. Although only one mobile device 140 is shown, in other embodiments, any number may be present. In the example shown, mobile device 140 recognizes that hotspot-access point 120 is available and may choose to register for the services supplied by the hotspot-access point 120 if mobile device 140 is configured to accept such services. If mobile device 140 registers with network 110 via hotspot-access point 120, network 110 confirms the access privileges by confirming authorization with one or more authorization servers 150. Once authorized, mobile device 140 may then request or accept location-based services that are implemented using instant-messaging server 160 and supplied through network 110 and hotspot-access point 120 or 130. Although only one authentication server 150 and one instant-messaging server 160 are shown connected to network 110, any number may be present. Although authentication server 150 and instant-messaging server 160 are shown to be separate, in another embodiment, they may be the same server.

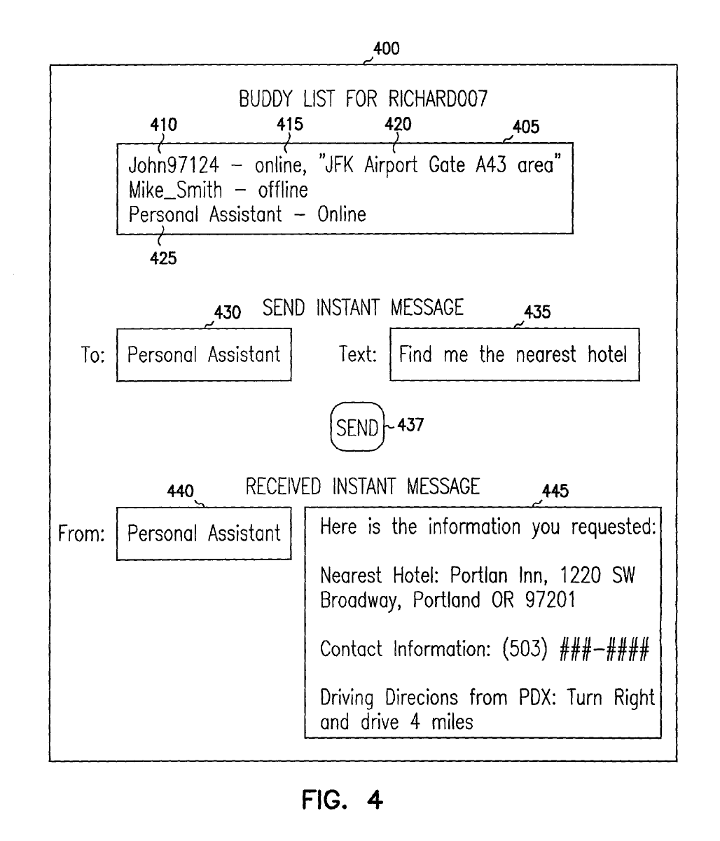

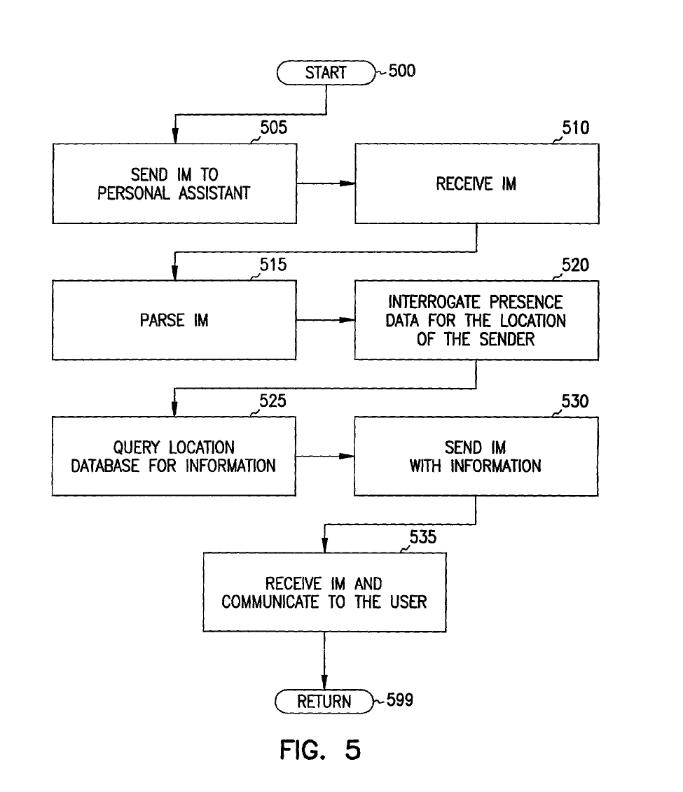

FIG. 2 depicts a block diagram of instant-messaging server 160, according to an embodiment of the invention. Instant-messaging server 160 receives instant messages across network 110 from mobile devices, such as mobile device 140, and provides location-based services, as further described below with reference to FIGS. 4 and 5. Referring again to FIG. 2, instant-messaging server 160 may be a server computer. Instant-messaging server 160 may use any suitable instant-messaging functions, such as those provided by AOL (America Online), Yahoo!, or Microsoft MSN Messenger Service, but any other suitable instant-messaging functions may be used. In another embodiment, instant-messaging server 160 may be implemented by a paging service. Instant-messaging server 160 may be implemented using any suitable hardware and/or software, such as a personal computer available from a number of vendors. But, other examples may be portable computers, laptop computers, and mainframe computers. The invention is not so limited. Instant-messaging server 160 may support any suitable instant-messaging protocol. In an embodiment, instant-messaging server 160 supports the Internet Engineering Task Force's (IETF) Instant Messaging and Presence Protocol.

Instant-messaging server 160 includes processor 235, storage device 240, and network adapter 245, all communicatively coupled via bus 280.

Processor 235 represents a central processing unit of any type of architecture, such as a CISC (Complex Instruction Set Computing), RISC (Reduced Instruction Set Computing), VLIW (Very Long Instruction Word), or a hybrid architecture, although any appropriate processor may be used. Processor 235 executes instructions and includes that portion of instant-messaging server 160 that controls the operation of the entire server. Although not depicted in FIG. 2, processor 235 typically includes a control unit that organizes data and program storage in memory and transfers data and other information between the various parts of the server. Processor 235 may receive input data from network 110 via network adapter 245, read and store code and data in storage device 240, and may present output data via network adapter 245 to network 110. Processor 235 may transmit and receive packets of information across network 110 using network adapter 245.

Although instant-messaging server 160 is shown to contain only a single processor and a single bus, the present invention applies equally to servers that may have multiple processors and to servers that may have multiple buses with some or all performing different functions in different ways.

Storage device 240 represents one or more mechanisms for storing data. For example, storage device 240 may include read only memory (ROM), random access memory (RAM), magnetic disk storage mediums, optical storage mediums, flash memory devices, and/or other machine-readable mediums. Although only one storage device 240 is shown, multiple storage devices and multiple types of storage devices may be present. Further, although instant-messaging server 160 is drawn to contain storage device 240, the storage device may be distributed across other electronic devices attached via network 110.

Storage device 240 includes personal-assistance controller 260, which may include instructions capable of being executed on processor 235 to carry out the functions of the present invention, as further described below with reference to FIG. 5. In another embodiment, some or all of the functions of the present invention may be carried out via hardware in lieu of a processor-based system. Referring again to FIG. 2, storage device 240 further includes presence data 265, location database 270, and buddy list 275. Presence data 265 includes presence information of mobile devices, including whether they are connected and online or disconnected and offline and their location. The location of a mobile device may be specified in terms of the hotspot-access point which connects the mobile device to network 110.

Location database 270 may contain information about various services, businesses, and other points of interest and their relationship to the various hotspot-access points. For example, location database 270 may contain information about various hotels, rental car companies, gas stations, restaurants, hospitals, and dry cleaners that are near the respective hotspot-access points. But, in other embodiments, location database 270 may contain any information of interest relative to a hotspot-access point. Although location database 270 is shown to be within instant-messaging server 160, in another embodiment location database 270 may be contained within another computer.

Buddy list 275 may contain a respective list of user names and other information of interest to each respective mobile device. Buddy list 275 is further described below with reference to FIG. 4.

Referring again to FIG. 2, of course, storage device 240 may also contain additional software and data (not shown), which are not necessary to understanding the invention.

Bus 280 represents one or more busses (e.g., PCI, ISA (Industry Standard Architecture), X-Bus, EISA (Extended Industry Standard Architecture), or any other appropriate bus) and bridges (also termed bus controllers).

Network adapter 245 facilitates communication between instant-messaging server 160 and network 110. Network adapter 245 provides a user of instant-messaging server 160 with a means of electronically communicating information, such as instant messages, with a remote computing device, such as hotspot-access points 120 and 130, mobile device 140, and authentication server 150. In addition, in another embodiment, network adapter 245 may support distributed processing, which enables instant-messaging server 160 to share a task with other devices linked to network 110. Although network adapter 245 is shown as part of instant-messaging server 160, in another embodiment they may be packaged separately. Although only one network adapter 245 is shown, in other embodiments, multiple network adapters of the same or of a variety of types may be present.

Instant-messaging server 160 may be implemented using any suitable hardware and/or software, such as a personal computer. Portable computers, laptop or notebook computers, mainframe computers, and network computers are examples of other possible configurations. The hardware and software depicted in FIG. 2 may vary for specific applications and may include more or fewer elements than those depicted. For example, other peripheral devices such as audio adapters, or chip programming devices, such as EPROM (Erasable Programmable Read-Only Memory) programming devices may be used in addition to or in place of the hardware already depicted. Thus, an embodiment of the invention may apply to any hardware configuration that supports instant messaging.

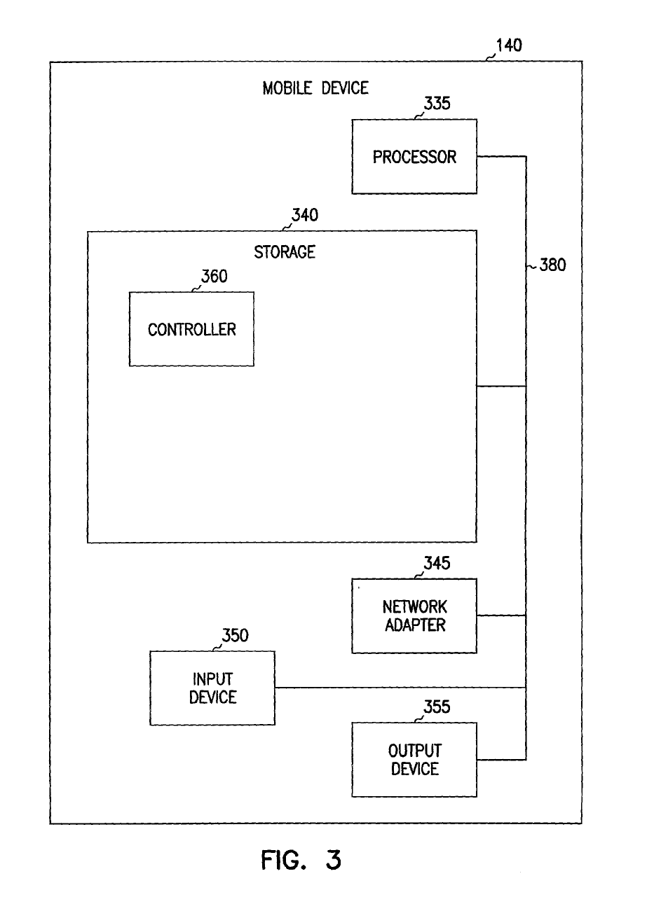

FIG. 3 depicts a block diagram of mobile device 140, which includes processor 335, storage device 340, network adapter 345, input device 350, and output device 355, all communicatively coupled via bus 380. Mobile device 140 is capable of sending and receiving instant messages and connecting to network 110 via a hotspot-access point, such as hotspot-access point 120 or 130.

Processor 335 represents a central processing unit of any type of architecture, such as a CISC (Complex Instruction Set Computing), RISC (Reduced Instruction Set Computing), VLIW (Very Long Instruction Word), or a hybrid architecture, although any appropriate processor may be used. Processor 335 executes instructions and includes that portion of mobile device 140 that controls the operation of the entire mobile device. Although not depicted in FIG. 3, processor 335 typically includes a control unit that organizes data and program storage in computer memory and transfers data and other information between the various parts of the mobile device. Processor 335 may receive input data from input device 350 and network adapter 345, read and store code and data in storage device 340, and may present output data to a user via output device 355. Processor 335 also may transmit and receive packets of information across network 110 via network adapter 345.

Although mobile device 140 is shown to contain only a single processor and a single bus, the present invention applies equally to mobile devices that may have multiple processors and to mobile devices that may have multiple buses with some or all performing different functions in different ways.

Storage device 340 represents one or more mechanisms for storing data. For example, storage device 340 may include read only memory (ROM), random access memory (RAM), magnetic disk storage mediums, optical storage mediums, flash memory devices, and/or other machine-readable mediums. Although only one storage device 340 is shown, multiple storage devices and multiple types of storage devices may be present. Further, although mobile device 140 is drawn to contain storage device 340, the storage device may be external to or removable from mobile device 140.

Storage device 340 contains controller 360, which may include instructions capable of being executed on processor 335 to carry out the functions of the present invention. In another embodiment, some or all of the functions of the present invention may be carried out via hardware in lieu of a processor-based system. Of course, storage device 340 may also contain additional software and data (not shown), which is not necessary to understanding the invention.

Bus 380 represents one or more busses (e.g., PCI, ISA (Industry Standard Architecture), X-Bus, EISA (Extended Industry Standard Architecture), or any other appropriate bus) and bridges (also termed bus controllers).

Input device 350 is that part of mobile device 140 that accepts input from a user. In an embodiment, input device 350 may be a keyboard, but in other embodiments, input device 350 may be a pointing device, mouse, trackball, keypad, touchpad, touch screen, pointing stick, microphone, or any other appropriate input device. Although only one input device 350 is shown, in other embodiments any number of input devices of the same or of a variety of types may be present.

Output device 355 communicates information to the user of mobile device 140. Output device 355 may be a cathode-ray tube (CRT) based video display well known in the art of computer hardware. But, in other embodiments output device 355 may be replaced with a liquid crystal display (LCD) based or gas, plasma-based, flat-panel display. In still other embodiments, any appropriate display device may be used. In yet other embodiments, a speaker that produces audio output may be used. Although only one output device 355 is shown, in other embodiments, any number of output devices of different types or of the same type may be present.

Network adapter 345 facilitates communication between mobile device 140 and network 110. Network adapter 345 provides a means of electronically communicating information, such as instant messages, with a remote computer, such as instant-messaging server 160. In addition, in another embodiment, network adapter 345 may support distributed processing, which enables mobile device 140 to share a task with other devices linked to network 110. Although network adapter 345 is shown as part of mobile device 140, in another embodiment they may be packaged separately. Although only one network adapter 345 is shown, in other embodiments, multiple network adapters of the same or of a variety of types may be present.

Mobile device 140 may be implemented using any suitable hardware and/or software, such as a personal computer or other electronic mobile device. Portable computers, laptop or notebook computers, hand-held devices, PDAs (Personal Digital Assistants), telephones, cellular telephones, smart phones, two-way alphanumeric pagers, and network computers or Internet appliances are examples of other possible configurations of mobile devices. In other embodiments, mobile device 140 may be any suitable type of electronic device capable of being moved from one location to another location. Moreover, mobile device 140 may be embedded within another structure, such as an automobile, motorcycle, airplane, boat, bicycle, or any other kind of moving apparatus.

The hardware and software depicted in FIG. 3 may vary for specific applications and may include more or fewer elements than those depicted. For example, other peripheral devices such as audio adapters, or chip programming devices, such as EPROM (Erasable Programmable Read-Only Memory) programming devices may be used in addition to or in place of the hardware already depicted. Thus, an embodiment of the invention may apply to any hardware configuration that supports instant messaging.

As will be described in detail below, aspects of an embodiment pertain to specific apparatus and method elements implementable on mobile devices and servers. In another embodiment, the invention may be implemented as a program product for use with a mobile device or server. The programs defining the functions of this embodiment may be delivered to a mobile device or server via a variety of signal-bearing media, which include, but are not limited to:

(1) information permanently stored on non-rewriteable storage media (e.g., read only memory devices within a mobile device such as CD-ROM readable by a CD-ROM drive;

(2) alterable information stored on rewriteable storage media (e.g., a hard disk drive or diskette); or

(3) information conveyed to a mobile device or server by a communications media, such as through a computer or telephone network accessed via network adapter 245 or 345, including wireless communications.

Such signal-bearing media, when carrying processor-readable instructions that direct the functions of the present invention, represent embodiments of the present invention.

FIG. 4 depicts a block diagram example of user interface 400 on output device 355 of mobile device 140, according to an embodiment of the invention. User interface 400 includes displayed buddy list 405 for user “Richard007,” which in this example is the user name associated with mobile device 140. The contents of displayed buddy list 405 were previously downloaded from buddy list 275 in instant-messaging server 160. Displayed buddy list 405 may contain name field 410, which identifies a selected user of interest to Richard007. Richard007 previously added selected users to buddy list 275. Displayed buddy list 405 may also contain reachability status field 415, which in this example contains “online” or “offline,” indicating whether the respective user is connected to instant-messaging server 160 and thus available to receive an instant message. Displayed buddy list 405 may also contain location information 420, which may contain a description of the hotspot-access point to which the respective user's mobile device is connected. Reachability status field 415 and location information 420 both contain presence information from presence data 265. Displayed buddy list 405 may also include personal assistant entry 425, which is not a physical user but instead refers to personal-assistance controller 260, from which the user of mobile device 140 may request information by sending an instant message, as further described below.

User interface 400 also includes an interface for sending an instant message to the recipient identified in recipient field 430, which in this example is “personal assistant,” which refers to personal-assistance controller 260. The text of the instant message to be sent is entered by the user into text field 435, which in this example is the English language query “Find me the nearest hotel.” When the user selects send button 437, controller 360 sends the text in text field 435 to the recipient identified by recipient field 430.

User interface 400 also includes an interface for receiving instant messages. In the example shown, after the message in text field 435 has been sent to personal-assistance controller 260, mobile device 140 receives response 445 from personal-assistance controller 260, which is identified as personal assistant 440 in user interface 400. Response 445 includes the information requested by the user of mobile device 140, including in this example the name, address, and telephone number of the nearest hotel to the location of mobile device 140 and driving directions from the location of mobile device 140 to the hotel.

The example data shown in FIG. 4 is for illustrative purposes only, and any appropriate data may be used.

FIG. 5 depicts a flowchart of processing, according to an embodiment of the invention. Control begins at block 500. Control then continues to block 505 where mobile device 140 sends an instant message containing a request for service to instant-messaging server 160 via network 110 and hotspot-access point 120. Control then continues to block 510 where instant-messaging server 160 receives the instant message.

Control then continues to block 515 where personal-assistance controller 260 parses the request in the instant message using a natural language parser. A natural-language parser takes as input a sentence and may use a dictionary and a set of grammar rules to determine the meaning of the input sentence. The parser may analyze the sentence and create an abstraction representation of the meaning of the sentence using the dictionary and the set of grammar rules, which are specific to a particular natural language, such as English. For example, the rules of English state that requests for information will have certain structures for asking about certain topics or asking specific questions about these topics. There are many types of natural language parsers available including a Top-Down-Depth-First parser, a Top-Down-Breadth-First parser, and Bottom-Up-Depth-First-Chart parser.

Control then continues to block 520 where personal-assistance controller 260 obtains the location of mobile device 140 from presence data 265. Control then continues to block 525 where personal-assistance controller 260 obtains information regarding the request from location database 270 based on the meaning obtained from parsing the request and the location of mobile device 140. Control then continues to block 530 where personal-assistance controller 260 sends the information obtained from location database 270 to mobile device 140 as an instant message via network adapter 245, network 110, and hotspot-access point 120. Control then continues to block 535 where mobile device 140 receives the instant message and communicates it to the user via output device 355. Control then continues to block 599 where the processing returns.

1-25. (canceled)

26. A method, comprising:
receiving a first message from a sending device, the sending device being associated with a vehicle and the message including location information;
determining a location of the sending device from the location information; and
sending an instant message to the sending device, wherein contents of the instant message are dependent on the location of the sending device.
